(19) United States
(12) Patent Application Publication
(10) Pub. No.: US 2017/0208653 A1
(43) Pub. Date: Jul. 20, 2017

(54) DEVICE FOR POSITIONING AT LEAST ONE ELECTRODE FOR SMELTING FURNACES

(71) Applicant: FAST TECHNOLOGY S.R.L., Buia (IT)

(72) Inventors: Valter IOB, Gemona Del Friuli (IT); Gianpietro ULIAN, Joannis (IT)

(21) Appl. No.: 15/409,981

(22) Filed: Jan. 19, 2017

(30) Foreign Application Priority Data
Jan. 19, 2016 (IT) 102016000004225

(51) Int. Cl. H05B 7/07; H05B 7/109; H05B 7/102

(52) U.S. Cl. CPC H05B 7/07; H05B 7/102; H05B 7/109; F27B 2014/068

(57) ABSTRACT

A device for positioning at least one electrode for smelting furnaces includes a container made of metal structural work lined with refractory material (crucible) and a water-cooled structure and by a lid or roof with which vertical electrodes are associated, each one being slideably associated with temporary locking elements, such as a column locking clamp. The device is arranged to the side of a smelting furnace and below a parking position of the electrodes in the periods of interruption of operation of the smelting furnace. The device is constituted by a fixed base with which at least one lifting element, which can slide vertically with respect to the fixed base and is provided with elements that are adapted to determine its position in terms of height and is provided with a load cell, is associated in an upper region.

### CROSS-REFERENCED TO RELATED APPLICATIONS

This application is related to and claims the benefit of Italian Patent Application No. 102016000004225, filed on Jan. 19, 2016, the contents of which are herein incorporated by reference in its entirety.

### TECHNICAL FIELD

The present disclosure relates to a device for positioning at least one electrode for smelting furnaces.

### BACKGROUND

Nowadays the use is known, in foundries for metals, of smelting furnaces, in particular direct-arc furnaces, which are substantially electric arc furnaces that convert electricity to heat energy and are therefore used in the iron and steel industry for the production of raw materials or alloys, by way of melting the components by heating.

Such furnaces are usually constituted by containers made of steel structural work, lined internally with refractory material (crucible) and are supported by a structure, cooled with circulating water, which further makes it possible to obtain different inclinations according to the operation that is to be carried out, such as pouring and slagging operations.

There is also a lid provided with from one to three holes, through which the electrodes pass, and a fourth hole for sucking out the fumes that are produced during the smelting process, and an additional fifth hole for introducing the additives to assist smelting and refining

Such furnaces can be conducting-hearth, with one or more electrodes powered by direct voltage, or non-conducting hearth, powered by a three-phase system, usually at the mains frequency, and provided therefore with three graphite vertical electrodes which, as mentioned, penetrate the crucible and are arranged according to the corners of an equilateral triangle.

The arc fires between the ends of the three electrodes and the metallic load (the material to be melted), which is traveled through by the current; the electricity is converted to heat (Joule effect) which is transmitted to the rest of the load mainly by irradiation.

In these furnaces, graphite electrodes are used almost exclusively because they are much more resistant to oxidation and therefore to wear, they have good thermal and electrical conductivity, and they have a low dilation coefficient.

Such electrodes are usually constituted by multiple individual electrodes which can be made female/female and joined by way of male/male nipples (also made of graphite but mechanically stronger) or they can be made male/female and joined directly together so as to define a column, which are retained and moved according to the vertical axis by a column locking clamp, arranged above a movable roof.

An example of such device is illustrated in US2011089617A1.

The task of the column locking clamp is to immobilize and firmly retain the electrode column positioned inside the crucible, to transfer the electricity by way of a conductive element (shoe) to the electrode column and to induce movements to adjust the electrode column.

The positioning of the electrodes is of considerable importance given that they must be kept at a preset height with respect to the metallic load to be smelted; on the basis of the volumetric shape structure that the load or the melt will assume, it is necessary to re-adapt such height in order to stabilize the length of the electric arc, thus contributing to maintain the absorption of energy of the furnace practically constant.

Such adjustment occurs by way of a movement of the column supporting aim, in the direction of the vertical axis of the electrode column, thus inducing a consequent and equal movement of the electrode column locked integrally with the vise.

It has been found however that each electrode arranged inside the smelting crucible, owing to the high electrical currents that pass through it together with the oxidation of the graphite from which it is made and last but not least owing to the thermal stress to which it is subjected, is subject to wear (oxidation) of the part that is inside the crucible.

It has been found that usually the wear in arc furnaces for steel production is variable according to the type of furnace, the quantity of steel produced, the productive efficiency etc.

In any case, it can be an equivalent portion comprised between 1 and 5 kg per ton of melted material produced.

It is therefore known to ensure that the worn part of the electrode is made up for by sliding, through the locking vise, the column into the crucible and repositioning it by a portion sufficient to reconstitute the worn portion.

As a consequence, new electrodes need to be gradually added to the electrode column, by way of a procedure carried out manually or by way of robots, which are stacked on each other, with nipple joints, to form a kind of “totem”.

But the system of using a vise on the column supporting arm does not, to date, allow sliding to reposition the electrode column while the electrodes are actually being traversed by electric current and are engaged in the generation of heat energy.

Currently the most common procedures for extending and repositioning the worn portion of the column can be categorized into three types: all of them entail the presence of one or more operators in proximity to the furnace, at times on walkways arranged above those furnaces, and exposed to great heat and to the gases and fumes that issue therefrom.

Evidently, since almost all plants operate on a continuous cycle, the compensating extension of the electrode has to be done during its operation, although with the electricity suspended.

Furthermore the conventional procedures entail proceeding as follows: the electricity is cut off, the column supporting arm is lowered into the electric furnace until the electrode column is resting on the scrap metal; then the locking vise is opened (thus allowing the sliding of the column); subsequently the column supporting arm is raised by the portion corresponding to the necessary replenishment; the locking vise is closed; the column supporting arm is raised in order to detach the electrode column from the scrap metal; then the electricity is restored.

Alternatively, the electricity is cut off, the upper part of the electrode column is engaged with the gantry crane by way of a dedicated lifting apparatus; then the locking vise is opened (thus allowing the sliding of the column); subsequently the column supporting arm is raised by the portion corresponding to the necessary replenishment; the locking vise is closed; the lifting apparatus is disengaged; then the electricity is restored.

Alternatively, the electricity is cut off, during the step of loading the scrap metal into the furnace, the lid of the furnace, together with the electrode column, is rotated in order to allow access thereto; the electrode column is lowered and rested on a dedicated pedestal; then the locking vise is opened (thus allowing the sliding of the column); subsequently the column supporting arm is raised by the portion corresponding to the necessary replenishment; the locking vise is closed; the column supporting arm is raised in order to be able to close the lid of the furnace; then the electricity is restored.

All the procedures described above have the following limitations and drawbacks: they require manual and physical labor by operators in environmental conditions that at times are almost unbearable; they lack common and standardized practices that entail modes of conduct that comply with standard safety specifications; they necessitate a good view of the furnace in order to coordinate the manual operations; they depend on the capacities for assessment and synchronization of the individual operators; there is a high margin for error and riskiness of the operations, which can be the cause of accidents and injuries; the repositioning operations are not optimized and do not follow the gradual wear of the electrode column during the process, but are limited to 2-3 times for each new element; they are not economic since they induce the decay of yields in the process, in addition to not pursuing energy efficiency.

All this entails the incidence of injuries to persons, economic damage such as the inefficiency of absorption of electricity and the prolonging of interruptions of the electric current, because currently they have to be carried out manually by the workers at the furnace, and the manual procedures can furthermore involve collisions and/or incorrectly executed maneuvers with the concomitant possible breakage of the electrode column and consequent possible falling thereof or of its parts; there are also factors of inconstancy, from the point of view both of electrical behavior and of thermal behavior, as well as the incidence of unwanted electrical/physical turbulence which negatively influences the process inside the crucible (short circuits, great and extremely sharp variations in active and reactive power, low-frequency flickering), which entail a decrease in electrical efficiency.

JPH06260281A is also known, which discloses a system that calculates the distance L23 between the surface of the melted material in a smelting furnace and the face of the electrode, by taking a series of measurements during the operation of the smelting furnace and with the electrode arranged inside the furnace proper.

Such distance L23 is calculated by applying the following equation L23=L22−L16, where L22 is the distance between the face of the electrode and the bottom of the smelting furnace, and L16 is the height of the surface of the melted material with respect to the bottom of the smelting furnace.

In particular, the distance L22 is calculated by applying the following equation: L22=L21−L20−L15, where:

L21 is the height of a detector, arranged outside the furnace, with respect to the bottom of the smelting furnace, and is preset and known,

L20 is the length of the electrode which is calculated based on the weight of the electrode, measured by a sensing device,

L15 is the distance between the detector and the upper end of the electrode, which is calculated by a pulse encoder.

The height L16 is calculated by applying the following equation: L16=L18−L17, where:

L18 is the distance between a level gauge, arranged inside the furnace, and the bottom of the smelting furnace, and is preset and known,

L17 is the distance between the level gauge and the surface of the melted material, calculated by the level gauge.

Such solution has many drawbacks, which are linked to the fact that the system described carries out all the measurements necessary to calculate the distance L23 during the operation of the smelting furnace with the electrode arranged inside the furnace: all such measurements (L15, L17 and the weight of the electrode) cannot in fact be taken with precision since the electrode is not visible during such measurements and as a consequence it is not possible to verify the presence of alterations in the electrode proper; in fact the shape of the electrode, and in particular its face, can, with use, change both in shape and in diameter as a function of the parameter of the furnace and of the wear incurred.

Furthermore the fact that these measurements are taken with the electrode arranged inside the furnace, while it is in operation, gives rise to considerable limitations on the maintenance of the apparatuses and on their accuracy in the measurements performed, since, by virtue of the electric arc, the entire furnace and the corresponding mechanisms vibrate intensely with the additional risk that flames and smoke might exit from the furnace which cannot be perfectly sealed owing to residues of scrap metal and/or slag that become interposed between the lid and the furnace proper.

Finally, the measurements taken with the electrode arranged inside the furnace, while it is in operation, lack precision owing to the influence of the considerable magnetic fields that are generated by the extremely high electrical currents (up to 120,000 A) that pass through the electrical cables and the electrodes.

It is therefore clear that even the lengths and the distances (L23, L22, L16, L20) are imprecise given that they are calculated on the basis of the measurements taken with the electrode arranged inside the furnace (L15, L17 and the weight of the electrode).

Furthermore, the fact that the length L20 of the electrode is calculated based on the weight of the electrode measured by the sensing device entails a further imprecision in the calculation of the final value since the weight/length conversion of the electrode gives rise to errors owing to the tolerance allowed in the diameter of the electrode and the specific weight of the electrode, which both depend on the materials used to make them (as specified in the international IEC 60239:2005 standards regulating the dimensions and designation of graphite electrodes for electric arc furnaces).

Furthermore the weight/length conversion entails further errors since the shape of the face of the electrode is not perfectly cylindrical and therefore the diameter of the face will be smaller than the nominal diameter that is selected on the basis of the weight.

A further drawback consists in that such system is structurally and methodologically complex, requiring the calculation of many heights and/or lengths and/or distances by way of many detectors or sensors (the detector, the sensing device, the pulse encoder, the level gauge) which increase both the production costs and the costs of maintaining the furnace.

U.S. Pat. No. 6,115,405A is also known, which discloses a system for determining the position in terms of height of an electrode that can move vertically inside an arc furnace, while the furnace is in operation; such system comprises an electrode which is installed on an electrode supporting arm connected to a moveable shaft to the lower end of which an extendable and flexible chain is attached, which in turn is connected to a fixed load cell.

The position in terms of height of the electrode is obtained by determining the position of the shaft since it contributes to the vertical movement of the electrode.

The furnace is initially full of scrap metal which is smelted with the assistance of an arc which is generated between the electrode and the scrap metal.

In a first step, the electrode descends toward the scrap metal and, in melting it, creates a hole, until, at a certain point, it collapses; the collapse is responsible for a short circuit of the electrode which extinguishes the arc.

As a consequence the electrode is lifted in a second step.

In a third step the electrode moves in the furnace, above the melt, in order to be subsequently lowered back down in a different area.

The electrode therefore constantly moves up and down vertically, always inside the furnace.

The load cell provides a signal that corresponds to the portion of weight it supports in order to determine the position in terms of height of the electrode, and it converts this portion of weight to an electrical signal which is transmitted to a unit for display, by way of a wire.

In this solution too, the determination of the position in terms of height of the electrode cannot be done with precision since it is performed with the electrode arranged inside the furnace and during the operation of the furnace itself, without taking into consideration the changes and alterations that the face of the electrode undergoes, during use, both in shape and diameter as a function of the parameter of the furnace and of the wear incurred.

JP2000306662A is also known, which discloses a device that measures the weight of three electrodes in a smelting furnace in which there are three electrode supporting arms for clamping and holding the electrodes, a movable column for supporting the electrodes, and rotation means for rotating the electrode supporting arms about the axis of the column in order to move the electrodes out of the furnace.

The device that measures the weight is outside the furnace and comprises a single base which is integral with three protruding bodies for supporting the faces of the electrodes, and three load cells, which are arranged below the supporting bodies, in order to determine the weight of the electrodes.

Once the rotation means move the electrode supporting arms outside the furnace, the column is lowered in order to simultaneously position all three electrodes in the three underlying supporting bodies which, by means of the load cells underneath, measure only the weight of the electrodes.

Such solution is limited since it describes only a device that is capable of determining the weight of three electrodes without determining their position and without foreseeing any repositioning thereof

### SUMMARY

The aim of the present disclosure is to eliminate the above mentioned drawbacks, by providing a device that makes it possible to perform, rapidly and easily, the consumption control of each individual electrode (or even just of the one with anomalous wear) and the subsequent optimization of its position in terms of height.

Within this aim, the present disclosure provides a device that makes it possible to eliminate the exposure of the operators to the risks deriving from the conventional operations.

The disclosure also provides a device that makes it possible to eliminate the risk of breakage of the electrodes.

The disclosure further provides a device that makes it possible to optimize the quality of the extension and repositioning, in terms of extent, precision, and frequency of intervention, with consequent reduction of the wear of the desired one or of all (taken individually) the electrodes and of the consumption of electricity.

The disclosure also provides a device that makes it possible to optimize the use of the smelting plant through a better operating efficiency.

The disclosure further provides a device that is structurally simple and low cost and can be made with the usual conventional systems.

These advantages and features which will become better apparent hereinafter are achieved by providing a device for positioning at least one electrode, usable in electric smelting furnaces that are constituted by a container made of metal structural work lined with refractory material (crucible) and a water-cooled structure and by a lid or roof with which vertical electrodes are associated, each one being slideably associated with temporary locking elements, such as a column locking clamp, characterized in that it is arranged to the side of said smelting furnace and below the parking position of said electrodes in the periods of interruption of operation of said smelting furnace, and in that it is constituted by a fixed base with which at least one lifting means, which can slide vertically with respect to said fixed base and is provided with means that are adapted to determine its position in terms of height and is provided with a load cell, is associated in an upper region, said positioning device determining the position and the weight of each one of said electrodes individually and independently of the others, said positioning device being adapted to temporarily support and to vary the position in terms of height of each one of said electrodes individually and independently.

### BRIEF DESCRIPTION OF THE DRAWINGS

Further characteristics and advantages of the disclosure will become better apparent from the detailed description of a particular, but not exclusive, embodiment of the disclosure, which is illustrated by way of non-limiting example in the accompanying drawings wherein:

FIG. 1 is a view from above of a furnace with the roof open according to the disclosure;

FIG. 2 is a side view of the furnace with the roof open and the electrodes, extracted, positioned each above a positioning device;

FIG. 3 is a side view of the device in the non-elongated condition;

FIG. 4 is a side view of the device in the elongated condition;

FIG. 5 is a partially cross-sectional view of the device; and

FIGS. 6, 7, and 8 are views, similar to those in FIG. 2, showing the condition in which the device is elongated up to the height of the respective electrode, the condition in which the device has rebalanced the height of the electrodes following the loosening of the arm vise, and the subsequent condition in which, with the arm vise clamped shut, the device is lowered.

### DETAILED DESCRIPTION OF THE DRAWINGS

In the embodiments illustrated below, individual characteristics shown in relation to specific examples may in reality be interchanged with other, different characteristics, existing in other embodiments.

With reference to the figures, the reference numeral 1 designates a device for positioning at least one vertical electrode 2, advantageously of the column type and used in electric smelting furnaces 3 that are constituted by a container 4 made of metal structural work lined with refractory material (crucible) and a water-cooled structure and by a lid or roof 5 which further makes it possible to obtain different inclinations according to the operation that is to be carried out, such as pouring and slagging operations.

In the specific embodiment shown by way of example, the lid or roof 5, which rotates, is provided with one to three holes through which pass the vertical electrodes 2, preferably made of graphite, which penetrate into the crucible and are arranged, for a three-phase power supply, according to the vertices of an equilateral triangle.

It should be noted that the roofs do not always open and rotate with the electrodes (or are associated with them); in some furnaces the lid remains on the furnace and only the electrode assembly rotates to park or onto another adjacent furnace arranged in a twin shell arrangement (the same set of electrodes smelts on one furnace while the other is being loaded and thus in alternation); the device also applies to such types.

The vertical electrodes 2 are held and moved according to the vertical axis by locking elements 6 such as a conventional column locking clamp, arranged above the lid or roof 5 and associated with the end of a column supporting arm 7 protruding above the lid or roof 5 proper, said column locking clamp locking and firmly retaining the electrode column positioned inside the crucible, transferring the electricity, by way of a conductive element (shoe) to the electrode column, and inducing movements to adjust the electrode column.

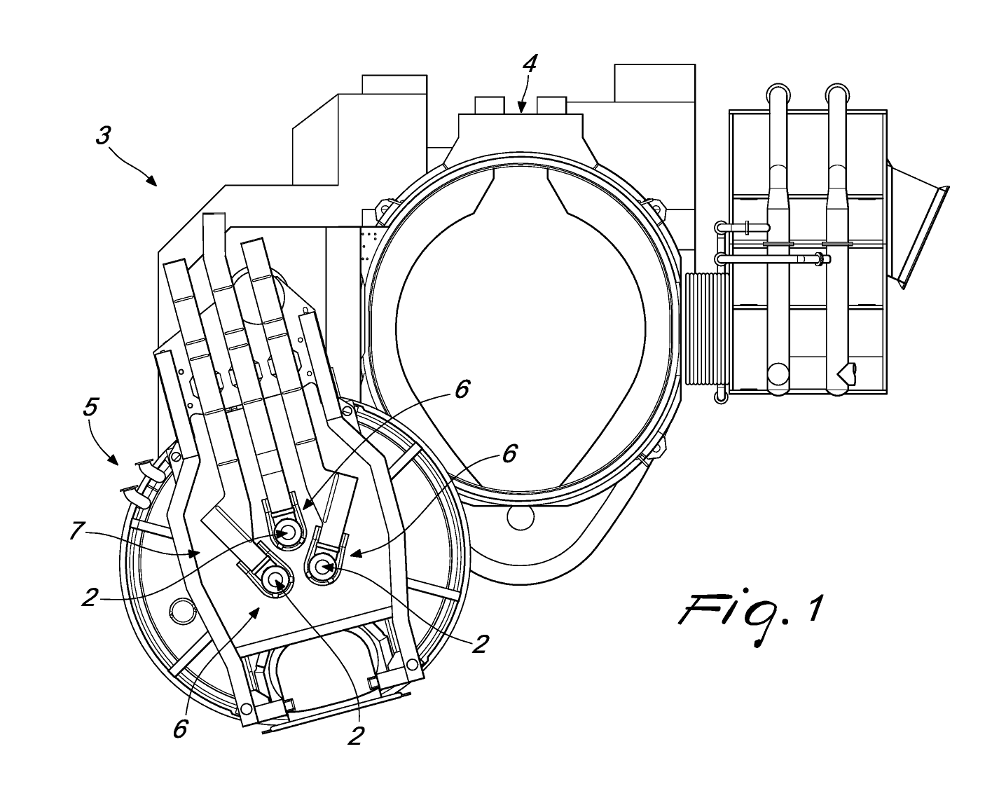

The device 1 is arranged to the side of the smelting furnace 3 below the parking position of the vertical electrodes 2 in the periods of interruption of operation of the electric smelting furnace 3, as shown in FIGS. 1, 2, 6, 7 and 8, and it is constituted by a fixed base 8 with which at least one lifting means 9, which can slide vertically on the latter, is associated in an upper region.

In the specific embodiment shown by way of example, the base 8 is fixed to the floor, at the position in which the lid or roof 5 of the smelting furnace 3 equipped with the electrodes 2 is parked in the periods of interruption of operation, by means for example of a complementary plate embedded in the concrete and provided with adapted screws that cooperate with adapted locking nuts.

Three lifting means 9 are associated with the fixed base 8 in an upper region, are structurally identical and can slide vertically with respect to the fixed base 8 independently of each other.

Each lifting means 9 is constituted by a head 10 that can move vertically and independently of the others by virtue of its interaction with adapted actuators, for example of the hydraulic fluid type or other type.

In the particular embodiment, each hydraulic fluid actuator is provided with hydraulic cylinders 11 which are adapted to move the corresponding head 10 by way of adapted rods 12 protruding from an upper plate 13; a tank 14 is provided for containing the hydraulic fluid while the hydraulic cylinders 11 rest on a container 15 for an electric motor 16 that actuates an adapted hydraulic pump 17.

Each head 10 is integral with the respective lifting means 9 that rests against the rods 12 of the cylinders 11.

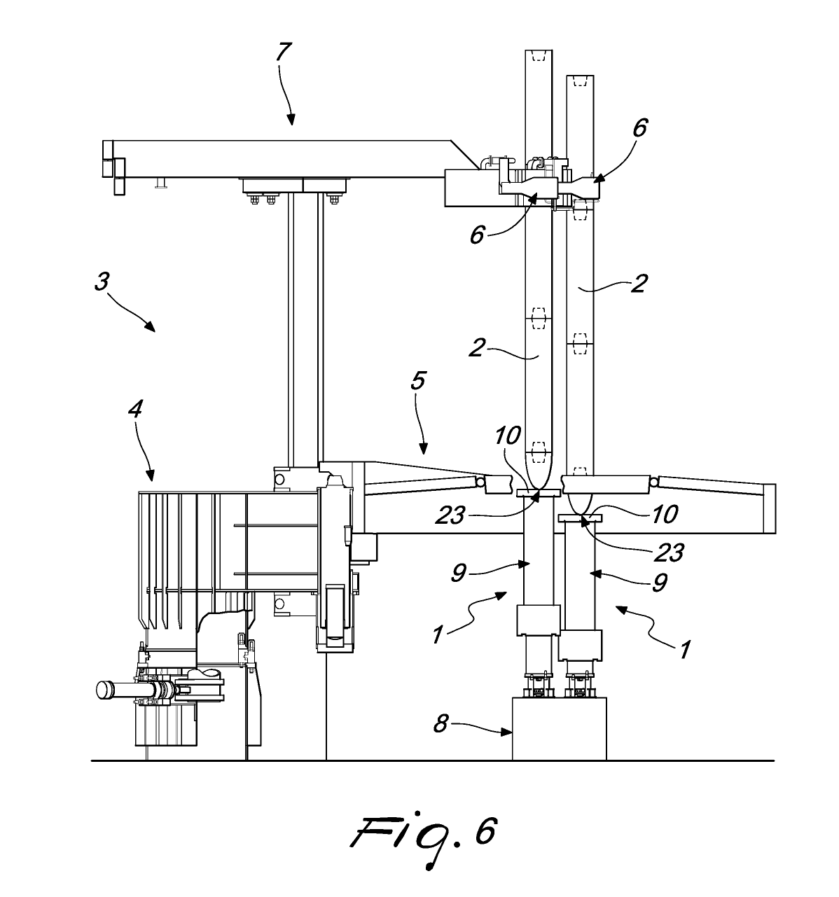

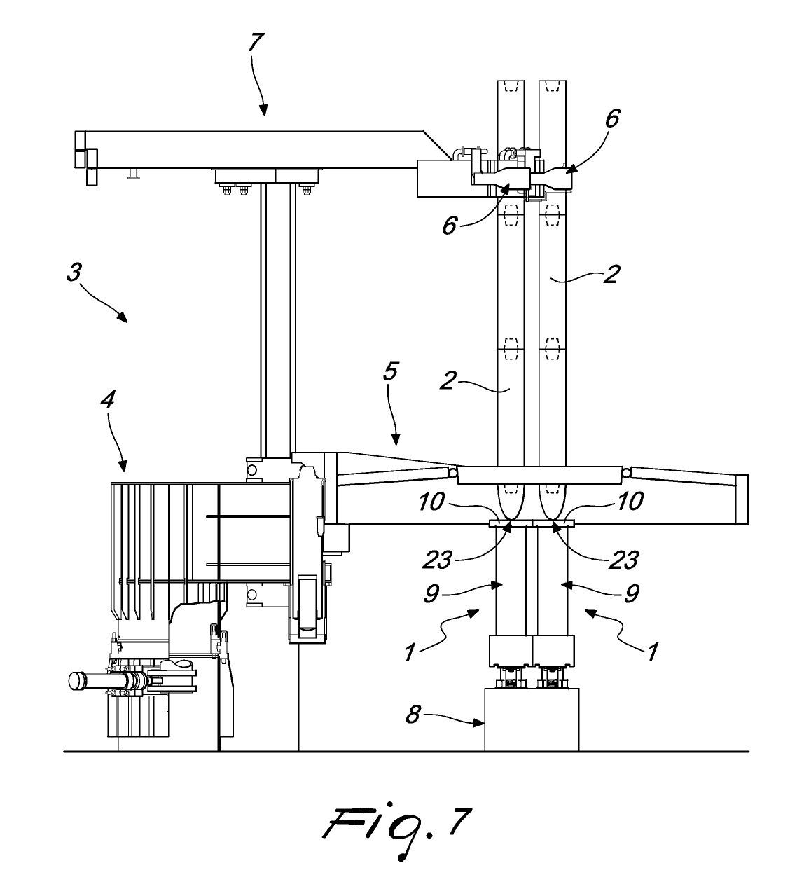

Each container 15 rests on the base 8 and is provided thereat with a load cell 18 that is adapted to determine the weight of each electrode 2 in the step in which the lifting means 9 rests the head 10 on the electrode 2 after the release of the column locking clamp, as illustrated in FIG. 6.

In each lifting means 9 there are also means adapted to determine the position of the respective electrode 2 independently of the other lifting means 9, said means being constituted by adapted switches or stroke limiters 19, probe/cams of the stroke limiters 20, and linear position transducers 21 that interact with the rods 12.

Both the base 8 and the lifting means 9 are constituted preferably by steel structures provided optionally with adapted cooling systems, which comprise adapted connections 22a, 22b that are accessible externally to each one of the lifting means 9.

Each individual lifting means 9 slides, independently of the others, vertically with respect to the fixed base 8 so that the consumed electrode 2 interacting thereon is repositioned at the desired height while the remaining lifting means 9 of the remaining electrodes 2 can remain positioned in the inactive condition.

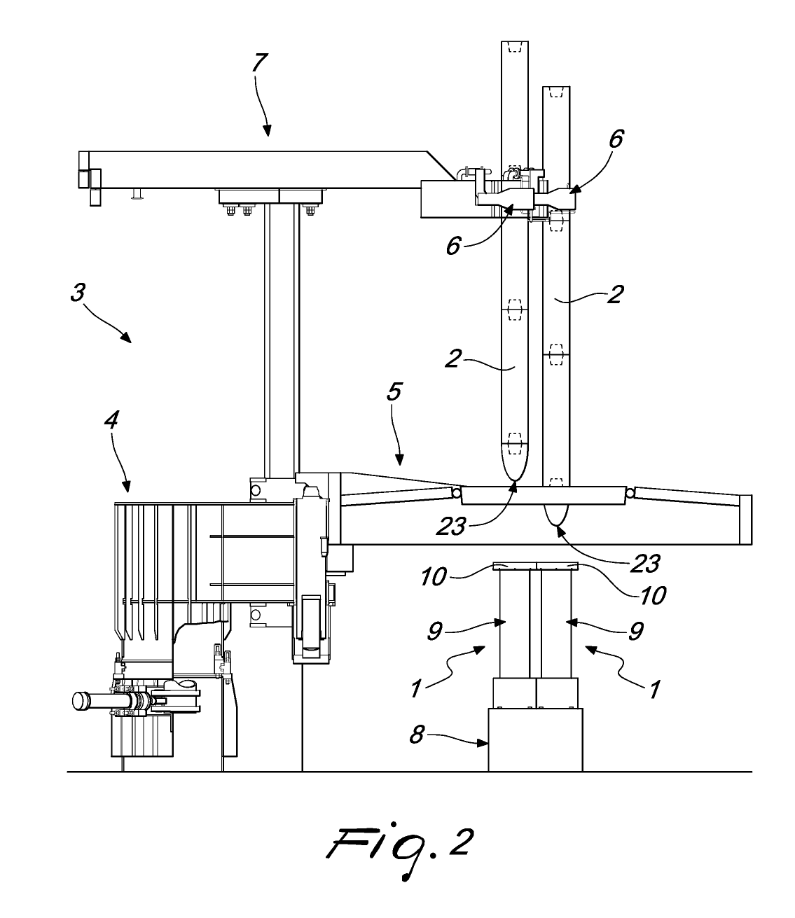

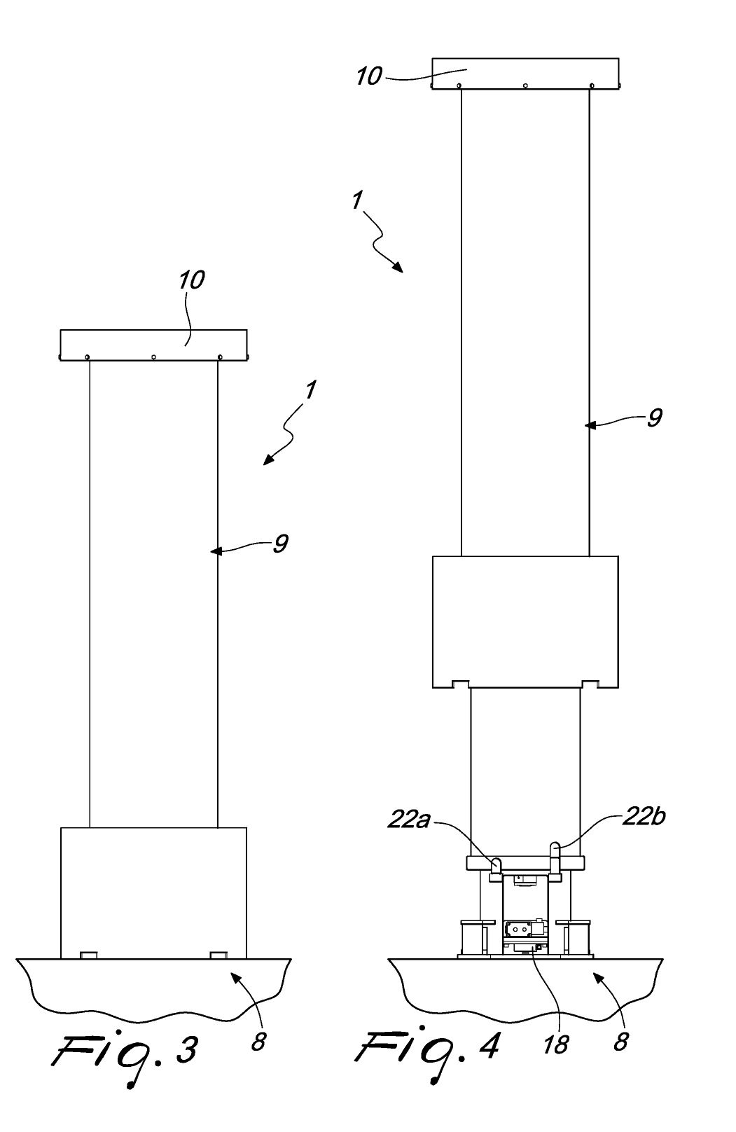

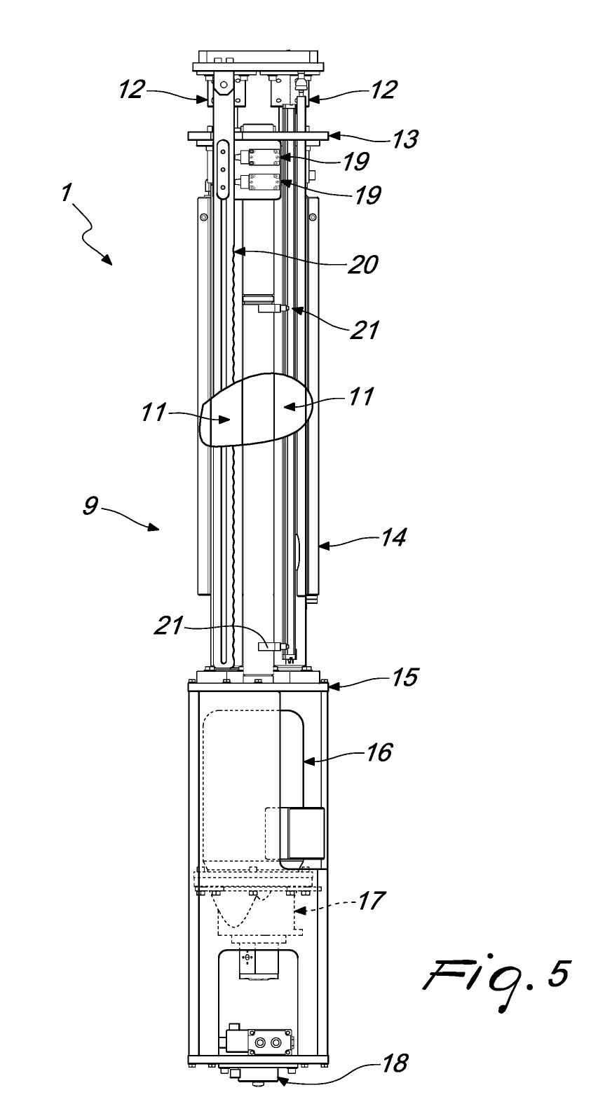

In the inactive condition the lifting means 9 is completely retracted, as shown in FIG. 2; in active conditions it is lifted, as shown in FIG. 6, until the head 10 is placed in contact with the lower end 23 of the respective electrode 2, controlling its actual height and constituting a resting element for the subsequent exact repositioning to size.

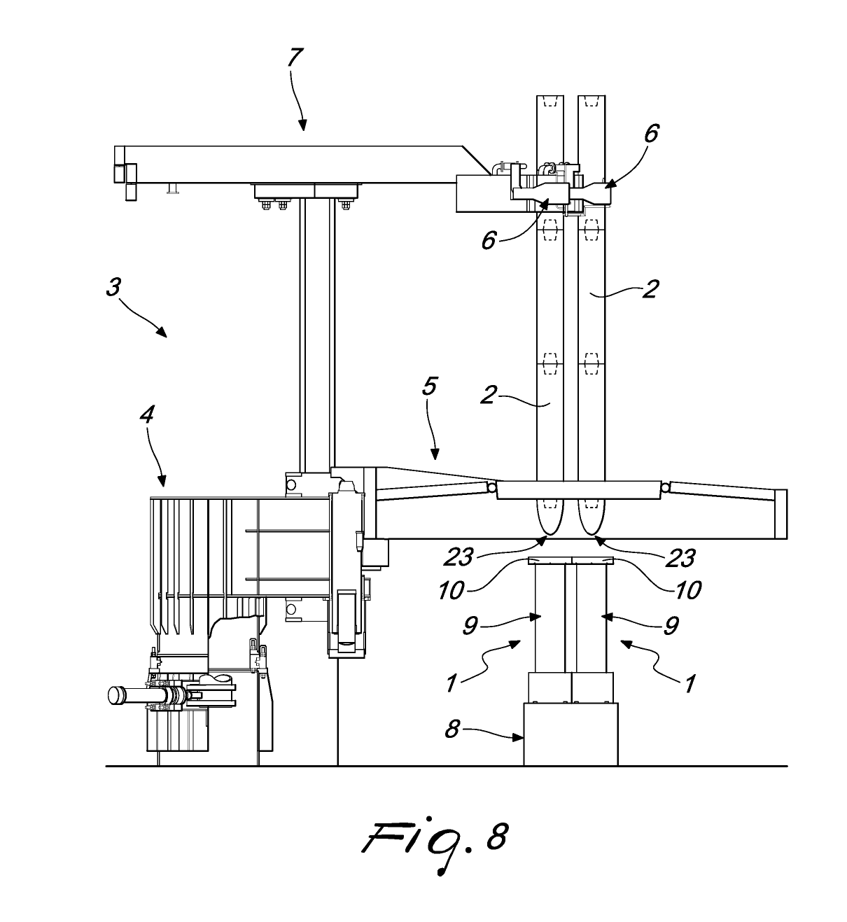

In the specific embodiment shown by way of example, the electrode 2 resting on the head 7 is subsequently released by the locking element 6 associated with the lid or roof 5, and the lifting means 9 is activated and causes the electrode 2 to descend, following it until it is arranged at a desired and preset height, as shown in FIG. 7.

The lifting means 9 also simultaneously performs, by way of load cells, the weighing of the electrode for consumption control.

Once such preset height is reached, the electrode 2 is locked by the locking element 6.

The lifting means 9 at this point is made to descend, releasing the electrode 2 for its subsequent insertion into the furnace, as shown in FIG. 8.

Advantageously, there is a separate control panel which is fixed in a suitable position away from the positioning device 1 and which enables an operator to activate/deactivate one or more lifting means 9.

The actuations are automatic and manual, controlled with buttons and they do not require manual intervention by the operator on the moving parts, since the operating area of the device 1 and the vicinities are off-limits to operators as they are exposed to very great radiating heat when the lid or roof 5 with the electrodes 2 is in a parking position outside the furnace 3.

Such areas are in fact usually segregated with enclosures.

In its operation the device 1 makes it possible to compensate the different wear of electrodes, balancing their length in such a manner that the portion of electrode passed through by the current is the same in all three electrode columns and the system is more balanced, thus improving the electrical and thermal efficiency.

The condition is further avoided whereby the electrode is too short and the column supporting arm does not have enough travel to keep the face of the electrode at the optimal distance (with the risk that the distance from the scrap metal/melt is too great for the arc to be generated).

As the electrodes 2 are worn away and are repositioned in terms of height, new electrodes 2 are added to the initial column, a procedure usually carried out manually or by way of robots, by way of a simple and rapid stacking one above the other, using nipple joints.

The device 1 makes it possible to achieve the following advantage: the portion of electrode passed through by the current will be the same in all three electrode columns and the system will thus be more balanced, thus improving the electrical and thermal efficiency.

There is also the advantage that the electrode columns will never be too short.

Thus it has been found that the disclosure fully achieves the intended advantages by providing a device that makes it possible to perform, rapidly and easily, the consumption control of each individual electrode (or even just of the one with anomalous wear) and the subsequent optimization of its position in terms of height, while eliminating the exposure of the operators to risks deriving from conventional operations, and eliminating the risk of breakage of the electrodes, and optimizing the quality of the extension and repositioning, in terms of extent, precision, and frequency of intervention, with consequent reduction of the wear of the desired one or of all (taken individually) the electrodes and of the consumption of electricity, thus optimizing the use of the smelting plant through a better operating efficiency.

The disclosure thus conceived is susceptible of numerous modifications and variations.

Naturally the materials used as well as the dimensions of the individual components of the disclosure may be more relevant according to specific requirements.

The characteristics indicated above as advantageous, convenient or the like, may also be missing or be substituted by equivalent characteristics.

1. A device for positioning at least one electrode, usable in electric smelting furnaces that are constituted by a container made of metal structural work lined with refractory material (crucible) and a water-cooled structure and by a lid or roof with which vertical electrodes are associated, each one being slideably associated with temporary locking elements, such as a column locking clamp, the device being arranged to a side of a smelting furnace and below a parking position of said electrodes in the periods of interruption of operation of said smelting furnace, wherein the device comprises a fixed base with which at least one lifting means, which slides vertically with respect to said fixed base and is provided with means that are adapted to determine its position in terms of height and is provided with a load cell, is associated in an upper region, said device determining a position and a weight of each one of said electrodes individually and independently of the others, said device being adapted to temporarily support and to vary the position in terms of height of each one of said electrodes individually and independently.

2. The device according to claim 1, wherein each one of said lifting means is constituted by a head that moves vertically and independently of the others by interacting with actuators, such as a hydraulic fluid actuator provided with hydraulic cylinders, which are adapted to move each one of said heads by way of rods protruding from an upper plate, each one of said hydraulic fluid actuators comprising a tank for containing the hydraulic fluid, said hydraulic cylinders resting on a container for an electric motor that actuates an adapted hydraulic pump, each one of said heads being integral with the respective said lifting means that rests on the respective said rods of said cylinders.

3. The device according to claim 2, wherein each one of said containers rests on said base and is provided with said load cell, each load cell being adapted to determine the weight of the respective electrode independently of the other load cells in the step in which the corresponding said lifting means places said head on said electrode after the release of said column locking clamp.

4. The device according to claim 2, wherein each one of said lifting means includes means adapted to determine the position of the respective said electrode independently of the other lifting means, each one of said lifting means being constituted by switches or stroke limiters, probes/cams of the stroke limiters, and linear position transducers that interact with said rods.

5. The device according to claim 2, wherein in an inactive condition said lifting means is completely retracted, while in an active conditions said lifting means is lifted until said head is placed in contact with the lower end of one of said electrodes, controlling its actual height and constituting a resting element for the subsequent exact repositioning to size.

6. The device according to claim 2, wherein in active conditions for said lifting means said electrode resting on said head is subsequently released by said locking element and said lifting means is subsequently activated and causes said electrode to descend, following it until it is arranged at a desired and preset height, said lifting means also performing simultaneously, by way of said load cells, a weighing of said electrode for consumption control.

7. The device according to claim 6, wherein in active conditions for said lifting means, once said preset height has been reached, said electrode is locked by said locking element, and said lifting means subsequently descends, releasing said electrode for its subsequent insertion into said smelting furnace.

8. The device according to claim 1, wherein each individual lifting means slides, independently of the others, vertically with respect to said fixed base so that a consumed electrode interacting thereon is repositioned at the desired height while the remaining lifting means of the remaining electrodes remains positioned in the inactive condition.

9. The device according to claim 1, wherein said vertical electrodes are retained and moved along the vertical axis by a column locking clamp arranged above said lid or roof and associated with the end of a column supporting arm that protrudes above said lid or roof, said column locking clamp temporarily locking and firmly retaining said electrodes, wherein in the periods of interruption of operation of said smelting furnace, said electrodes are positioned to the side of said container, made of metal structural work lined internally with refractory material, which constitutes said smelting furnace.

10. The device according to claim 1, wherein said base is fixed to the floor, at the position in which said lid or roof of said smelting furnace provided with said electrodes is parked in the periods of interruption of operation, by way of a complementary plate embedded in the concrete and provided with adapted screws that cooperate with adapted locking nuts, both said base and said lifting means being constituted by steel structures provided with adapted cooling systems, wherein the adapted cooling systems include adapted connections that are accessible externally to each one of said lifting means.
